(19) United States
(12) Patent Application Publication
(10) Pub. No.: US 2025/0024412 A1
(43) Pub. Date: Jan. 16, 2025

(54) LOCATION ACCURACY PREDICTION AT APPLICATION DATA ANALYTICS ENABLER

(71) Applicant: Lenovo (Singapore) Pte. Ltd., New Tech Park (SG)

(72) Inventors: Emmanouil Pateromichelakis, Viersen (DE); Dimitrios Karampatsis, Ruislip (GB)

(21) Appl. No.: 18/716,019

(22) PCT Filed: Jan. 19, 2022
(86) PCT No.: PCT/EP2022/051086

§ 371 Date: Jun. 3, 2024

(30) Foreign Application Priority Data
Dec. 3, 2021 (GR) 20210100843

(51) Int. Cl. H04W 64/00; H04L 41/14

(52) U.S. Cl. CPC H04W 64/00; H04L 41/14

(57) ABSTRACT

Apparatuses and methods for location accuracy prediction at application data analytics enabler. An apparatus includes a transceiver that receives (605) a first analytics parameter associated with a location measurement for a user equipment, UE, device. The apparatus includes a processor that derives (610) application layer analytics for location measurement accuracy for a target application of the UE, based on the first analytics parameter, and location accuracy measurements from at least one location service producer and determines (615) a second analytics parameter indicating a predictive adaptation of a location measurement accuracy in response to deriving the application layer analytics based on an application requirement of the target application.

### FIELD

The subject matter disclosed herein relates generally to wireless communications and more particularly relates to location accuracy prediction at application data analytics enabler.

### BACKGROUND

In wireless networks, location services (“LCS”) is inherently part of the 3GPP Architecture and radio access network (“RAN”) framework to enable the identification and standardized reporting of a UE's, or a group of UEs, location information. This location information may be exposed to the user equipment, external applications, application function, network operator, service provider, value added service providers and for public land mobile network (“PLMN”) internal operations. Given the large variety and number of use cases and applications that require LCS functionality, there is a need to develop an LCS framework that caters to each of the scenarios and use cases.

### BRIEF SUMMARY

Disclosed are procedures for location accuracy prediction at application data analytics enabler. Said procedures may be implemented by apparatus, systems, methods, and/or computer program products.

In one embodiment, a first apparatus includes a transceiver that receives a first analytics parameter associated with a location measurement for a user equipment (“UE”) device. In one embodiment, the first apparatus includes a processor that derives application layer analytics for location measurement accuracy for a target application of the UE, based on the first analytics parameter, and location accuracy measurements from at least one location service producer and determines a second analytics parameter indicating a predictive adaptation of a location measurement accuracy in response to deriving the application layer analytics based on an application requirement of the target application.

In one embodiment, a first method includes receiving a first analytics parameter associated with a location measurement for a user equipment (“UE”) device. In one embodiment, the first method includes deriving application layer analytics for location measurement accuracy for a target application of the UE, based on the first analytics parameter, and location accuracy measurements from at least one location service producer and determining a second analytics parameter indicating a predictive adaptation of a location measurement accuracy in response to deriving the application layer analytics based on an application requirement of the target application.

In one embodiment, a second apparatus includes a transceiver that transmits a request to an application data analytics enablement server (“ADAES”) for a location measurement accuracy parameter for a user equipment (“UE”) device, the location measurement accuracy parameter comprising at least one of a location accuracy prediction and a location accuracy sustainability for the UE. In one embodiment, the transceiver receives, from the ADAES in response to the request, a location accuracy analytics report, the location accuracy analytics report comprising at least one of a prediction for the location accuracy of the UE and a sustainability of the location accuracy for the UE.

In one embodiment, a second method includes transmitting a request to an application data analytics enablement server (“ADAES”) for a location measurement accuracy parameter for a user equipment (“UE”) device, the location measurement accuracy parameter comprising at least one of a location accuracy prediction and a location accuracy sustainability for the UE. In one embodiment, the second method includes receiving, from the ADAES in response to the request, a location accuracy analytics report, the location accuracy analytics report comprising at least one of a prediction for the location accuracy of the UE and a sustainability of the location accuracy for the UE.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for location accuracy prediction at application data analytics enabler;

FIG. 2 depicts an example procedure to derive analytics using location accuracy prediction at application data analytics enabler;

FIG. 3 depicts an example procedure to derive analytics for location accuracy for an expected UE route using location accuracy prediction at application data analytics enabler;

FIG. 4 is a block diagram illustrating one embodiment of a user equipment apparatus that may be used for location accuracy prediction at application data analytics enabler;

FIG. 5 is a block diagram illustrating one embodiment of a network apparatus that may be used for location accuracy prediction at application data analytics enabler;

FIG. 6 is a flowchart diagram illustrating one embodiment of a method for location accuracy prediction at application data analytics enabler; and

FIG. 7 is a flowchart diagram illustrating one embodiment of another method for location accuracy prediction at application data analytics enabler.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for location accuracy prediction at application data analytics enabler. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

LCS is inherently part of the 3GPP Architecture and RAN framework to enable the identification and standardized reporting of a UE's, or a group of UEs, location information. This location information can be exposed to the user equipment, external applications, application function, network operator, service provider, value added service providers and for PLMN internal operations. Given the large of variety number of use cases and applications that require LCS functionality, there is a need to develop a LCS framework that caters to each of the scenarios and use cases.

When verticals are considered, LCS is not a “one size fits all” paradigm. A location application programming interface (“API”), which may be offered to a vertical, may have completely different network handling and requirements for different scenarios. Providing different API exposures for different use cases may be a complex task that may require additional signaling and/or complexity at the network or application side to provide on time with the required quality of service (“QoS”).

Currently, the location services can be provided by multiple sources both from 3GPP and non-3GPP, such as a location management function (“LMF”), a service enabler architecture layer (“SEAL”) location management service (“LMS”), an edge platform (e.g., European Telecommunications Standards Institute (“ETSI”) mobile edge computing (“MEC”) location APIs, EDGEAPP Location API, and/or the like), a radio access network (“RAN”) or user equipment (“UE”), a non-3GPP network, a third party location service provider, and/or the like.

In one embodiment, one of the key metrics for location reporting is the accuracy that can be provided (e.g., it may be the main LCS QoS metric). Such accuracy may depend on the positioning methods that are used, the LCS producers, whether location fusion is supported as well as the UE mobility and the environment.

When the LCS consumer makes a location request, in one embodiment, it requires a certain location accuracy (e.g., centimeter-level, decimeter-level, meter-level, and/or the like); however, how the location accuracy is calculated at the entity that produces a location estimate and whether the accuracy can be maintained along a UE session (e.g., for a given time, area, route, and/or the like) is challenging to answer at the time of the request or subscription. Thus, the prediction of the location accuracy and its sustainability may be needed to make sure that the LCS producer will meet the customer location QoS requirements (e.g., for a given UE route or a given time or area of location request validity).

The following solution, in one embodiment, provides a method to allow a consumer of a location request to be notified based on analytics whether the accuracy of a location can be met for a given application and optionally for a given UE route or for a given group of UE route. For example, a consumer may request the data analytics server to provide analytics describing whether the accuracy of a location is less than a threshold in a specific area or when the UE moves from location A to location B.

It is proposed herein to use an external application layer data analytics enabler server (“ADAES”) to perform granular location accuracy analytics by leveraging the network data analytics function (“NWDAF”) to provide analytics for sustainability of accuracy of location, and real-time location reporting from multiple location service producers, on-demand. The ADAES, in one embodiment, collects from the NWDAF location accuracy analytics per UE or UE group and location reports from other producers (e.g., LMF, SEAL, MEC, non-3GPP networks, and/or the like) iteratively based on the fulfilment of the request location accuracy by the vertical application. The ADAES, in one embodiment, performs online analytics and provides to the consumer the requested location accuracy for the application and for a given location or UE route.

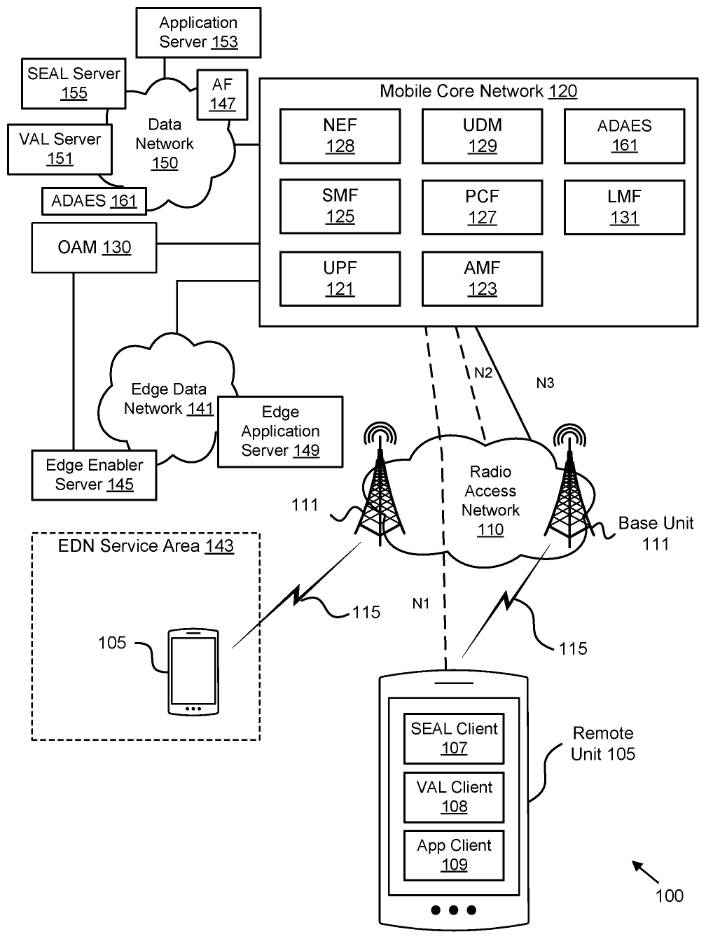

FIG. 1 depicts a wireless communication system 100 for location accuracy prediction at application data analytics enabler, according to embodiments of the disclosure. In various embodiments, the wireless communication system 100 includes at least one remote unit 105, a radio access network (“RAN”) 110, and a mobile core network 120. The RAN 110 and the mobile core network 120 form a mobile communication network. The RAN 110 may be composed of a base unit 111 with which the remote unit 105 communicates using wireless communication links 115. Even though a specific number of remote units 105, base units 111, wireless communication links 115, RANs 110, and mobile core networks 120 are depicted in FIG. 1, one of skill in the art will recognize that any number of remote units 105, base units 111, wireless communication links 115, RANs 110, and mobile core networks 120 may be included in the wireless communication system 100.

In one implementation, the RAN 110 is compliant with the 5G system specified in the 3GPP specifications. For example, the RAN 110 may be a NextGen RAN (“NG-RAN”), implementing NR Radio Access Technology (“RAT”) and/or Long Term Evolution (“LTE”) RAT. In another example, the RAN 110 may include non-3GPP RAT (e.g., Wi-Fi® or Institute of Electrical and Electronics Engineers (“IEEE”) 802.11-family compliant WLAN). In another implementation, the RAN 110 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

The RAN 110 may be composed of a Third Generation Partnership Project (“3GPP”) access network containing at least one cellular base unit and/or a non-3GPP access network containing at least one access point. The remote unit 105 communicates with the 3GPP access network using 3GPP communication links and/or communicates with the non-3GPP access network using non-3GPP communication links.

In FIG. 1, the wireless communication system 100 supports an edge computing service deployment including at least one edge data network (“EDN”) 141 supporting an EDN service area 143. The EDN 141 includes at least one Edge Application Server (“EAS”) 177 supporting an instance of an application. When a remote unit 105 is located in the EDN service area 143, Edge Application client 179 is able to access the EAS 177. However, when the remote unit 105 is outside any EDN service area, the EA client 179 is able to access an instance of the application using the Application server 171 located in the data network 150 (i.e., a regional data network). The EDN 141 also includes an edge enabler server (“EES”) 173, a middleware application enabler server, while the remote unit 105 includes an edge enabler client (“EEC”) 175. In other embodiments, the wireless communication system may support a future factories (“FF”) vertical and/or a V2X vertical (not depicted).

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as User Equipments (“UEs”), subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 111 in the RAN 110, e.g., via a 3GPP access network and/or a non-3GPP access network, via uplink (“UL”) and downlink (“DL”) communication signals. Furthermore, the UL and DL communication signals may be carried over the wireless communication links 115. Here, the RAN 110 is an intermediate network that provides the remote units 105 with access to the mobile core network 120. As depicted, the remote unit 105 may include hardware and software resources to run a SEAL client 107, a VAL client 108, and/or a mobile application client 109.

In some embodiments, the remote units 105 communicate with a communication host (e.g., edge application server 149, application server 153, SEAL server 155, and/or VAL server 151) via a network connection with the mobile core network 120. For example, a mobile application 109 (e.g., web browser, media client, telephone/Voice-over-Internet-Protocol (“VoIP”) application, mobile application client 109) in the remote unit 105 may trigger the remote unit 105 to establish a protocol data unit (“PDU”) session (or other data connection) with the mobile core network 120 via the RAN 110 (e.g., via the 3GPP access network and/or non-3GPP network). The mobile core network 120 then relays traffic between the remote unit 105 and the communication host (i.e., application server) using the PDU session. The PDU session represents a logical connection between the remote unit 105 and a User Plane Function (“UPF”) 121. Note that the remote unit 105 may establish one or more PDU sessions (or other data connections) with the mobile core network 120. As such, the remote unit 105 may concurrently have at least one PDU session for communicating with one application server and at least one additional PDU session for communicating with another application server (not shown).

In order to establish the PDU session (or Packet Data Network (“PDN”) connection), the remote unit 105 must be registered with the mobile core network 120 (also referred to as “attached to the mobile core network” in the context of a Fourth Generation (“4G”) system). Note that the remote unit 105 may establish one or more PDU sessions (or other data connections) with the mobile core network 120. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 121. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5QI”).

In the context of a 4G/LTE system, such as the Evolved Packet System (“EPS”), a PDN connection (also referred to as EPS session) provides E2E UP connectivity between the remote unit and a PDN. The PDN connectivity procedure establishes an EPS Bearer, i.e., a tunnel between the remote unit 105 and a Packet Gateway (“P-GW”), not shown, in the mobile core network 120. In certain embodiments, there is a one-to-one mapping between an EPS Bearer and a QoS profile, such that all packets belonging to a specific EPS Bearer have the same QoS Class Identifier (“QCI”).

The cellular base units 111 may be distributed over a geographic region. In certain embodiments, a cellular base unit 11 may also be referred to as an access terminal, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a Home Node-B, a relay node, a device, or by any other terminology used in the art. The cellular base units 111 are generally part of the RAN 110, such as a 3GPP access network, that may include one or more controllers communicably coupled to one or more corresponding cellular base units 111. These and other elements of radio access network are not illustrated but are well known generally by those having ordinary skill in the art. The cellular base units 111 connect to the mobile core network 120 via the RAN 110.

The cellular base units 111 may serve a number of remote units 105 within a serving area, for example, a cell or a cell sector, via a 3GPP wireless communication link. The cellular base units 111 may communicate directly with one or more of the remote units 105 via communication signals. Generally, the cellular base units 111 transmit DL communication signals to serve the remote units 105 in the time, frequency, and/or spatial domain. Furthermore, the DL communication signals may be carried over 3GPP communication links. The 3GPP communication links may be any suitable carrier in licensed or unlicensed radio spectrum. The 3GPP communication links facilitate communication between one or more of the remote units 105 and/or one or more of the cellular base units 111. Note that during NR operation on unlicensed spectrum (referred to as “NR-U”), the base unit 111 and the remote unit 105 communicate over unlicensed (i.e., shared) radio spectrum.

Non-3GPP access networks may be distributed over a geographic region. Each non-3GPP access network may serve a number of remote units 105 with a serving area. An access point in a non-3GPP access network may communicate directly with one or more remote units 105 by receiving UL communication signals and transmitting DL communication signals to serve the remote units 105 in the time, frequency, and/or spatial domain. Both DL and UL communication signals are carried over the non-3GPP communication links. The 3GPP communication links and non-3GPP communication links may employ different frequencies and/or different communication protocols. In various embodiments, an access point may communicate using unlicensed radio spectrum. The mobile core network 120 may provide services to a remote unit 105 via the non-3GPP access networks, as described in greater detail herein.

In some embodiments, a non-3GPP access network connects to the mobile core network 120 via an interworking entity. The interworking entity provides an interworking between the non-3GPP access network and the mobile core network 120. The interworking entity supports connectivity via the “N2” and “N3” interfaces. As depicted, both the 3GPP access network and the interworking entity communicate with the Access and Mobility Management Function (“AMF”) 123 using a “N2” interface. The 3GPP access network and interworking entity also communicate with the UPF 121 using a “N3” interface. The interworking entity may be a part of the core network 120 and/or the non-3GPP RAN.

In certain embodiments, a non-3GPP access network may be controlled by an operator of the mobile core network 120 and may have direct access to the mobile core network 120. Such a non-3GPP AN deployment is referred to as a “trusted non-3GPP access network.” A non-3GPP access network is considered as “trusted” when it is operated by the 3GPP operator, or a trusted partner, and supports certain security features, such as strong air-interface encryption. In contrast, a non-3GPP AN deployment that is not controlled by an operator (or trusted partner) of the mobile core network 120, does not have direct access to the mobile core network 120, or does not support the certain security features is referred to as a “non-trusted” non-3GPP access network. An interworking entity deployed in a trusted non-3GPP access network may be referred to herein as a Trusted Network Gateway Function (“TNGF”). An interworking entity deployed in a non-trusted non-3GPP access network may be referred to herein as a non-3GPP interworking function (“N3IWF”). While depicted as a part of the non-3GPP access network, in some embodiments the N3IWF may be a part of the mobile core network 120 or may be located in the data network 150.

In one embodiment, the mobile core network 120 is a 5G core (“5GC”) or the evolved packet core (“EPC”), which may be coupled to a packet data network 150, like the Internet and private data networks, among other data networks. A remote unit 105 may have a subscription or other account with the mobile core network 120. Each mobile core network 120 belongs to a single public land mobile network (“PLMN”). The present disclosure is not intended to be limited to the implementation of any particular wireless communication system architecture or protocol.

The mobile core network 120 includes several network functions (“NFs”). As depicted, the mobile core network 120 includes user plane functions (“UPFs”) 121. The mobile core network 120 also includes control plane functions including, but not limited to, an Access and Mobility Management Function (“AMF”) 123 that serves the RAN 110, a Session Management Function (“SMF”) 125, a Policy Control Function (“PCF”) 127, a Network Exposure Function (“NEF”) 128, a Unified Data Management function (“UDM”) 129, a Location Management Function (“LMF”) 131, and an ADAES 161. In certain embodiments, the mobile core network 120 may also include an Authentication Server Function (“AUSF”), a Network Repository Function (“NRF”) (used by the various NFs to discover and communicate with each other over APIs), or other NFs defined for the 5GC. In some embodiments, the UDM 129 is co-located with a User Data Repository (“UDR”).

The UPF(s) 121 is responsible for packet routing and forwarding, packet inspection, QoS handling, and external PDU session for interconnecting Data Network (“DN”), in the 5G architecture. The AMF 123 is responsible for termination of Non-Access Stratum (“NAS”) signaling, NAS ciphering & integrity protection, registration management, connection management, mobility management, access authentication and authorization, security context management. The SMF 125 is responsible for session management (i.e., session establishment, modification, release), remote unit (i.e., UE) IP address allocation & management, DL data notification, and traffic steering configuration for UPF for proper traffic routing.

The PCF 127 is responsible for unified policy framework, providing policy rules to Control Plane (“CP”) functions, access subscription information for policy decisions in UDR. The AUSF 148 acts as an authentication server.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 129.

In various embodiments, the mobile core network 140 may also include an Network Exposure Function (“NEF”) 128 (which is responsible for making network data and resources easily accessible to customers and network partners, e.g., via one or more APIs), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 120 may include an authentication, authorization, and accounting (“AAA”) server.

The LMF 131 is responsible for receiving measurements and assistance information from the RAN 110 and the remote unit 105, via the AMF 123 over the network links to compute the position of the remote unit 105, e.g., a UE.

In one embodiment, the ADAES 161 provides analytics describing whether the accuracy of a location measurement can be sustainable in a target area or period of time for a target application. In further embodiments, the ADAES 161 provides analytics describing whether the accuracy of a location measurement can be sustainable in a target area or period of time for one or more UEs routes within the application.

The ADAES 161, in one embodiment, includes an application entity, an application enablement entity, an application function, a network function, an application data analytics node, and/or the like. In one embodiment, the ADAES 161 is located on a network node, which may also include an application enablement server 153, the SEAL server 155, an application function, and/or the like, which may be external or internal to the mobile core network 120. For instance, the ADAES 161 may be accessible via an external data network 150 that is connected to the mobile core network 120 or may be located at the mobile core network 120 as an application function or network function.

In various embodiments, the mobile core network 120 includes several network services (not shown) that are produced by a network unit. The network unit may include a control plane service produced by a network function, a network management service produced by a management function, a mobile edge computing service produced by an edge data network function, an application enablement service produced by an application enabler function, a RIC service produced by an O-RAN unit, and/or the like.

As used herein, O-RAN is an alliance that investigates the virtualization of access domain and considers the virtualization of control functionalities (SON/RRM) to a newly defined RAN Intelligent Controller (“RIC”), which may be co-located with the gNB, can be deployed for a cluster of gNBs, and/or can be deployed at an edge node.

In one embodiment, RIC consists two different entities-a non-Real Time (“RT”) RIC, which is a logical function that enables non-real-time control and optimization of RAN elements and resources, AI/ML workflow including model training and updates, and policy-based guidance of applications/features in Near-RT RIC, and a near-RT RIC, which is a logical function that enables near-real-time control and optimization of RAN elements and resources via fine-grained (e.g., UE basis, cell basis, or the like) data collection and actions over an E2 interface.

In various embodiments, the mobile core network 120 supports different types of mobile data connections and different types of network slices, wherein each mobile data connection utilizes a specific network slice. Here, a “network slice” refers to a portion of the mobile core network 120 optimized for a certain traffic type or communication service. A network slice instance may be identified by a S-NSSAI, while a set of network slices for which the remote unit 105 is authorized to use is identified by NSSAI. In certain embodiments, the various network slices may include separate instances of network functions, such as the SMF 125 and UPF 121. In some embodiments, the different network slices may share some common network functions, such as the AMF 123. The different network slices are not shown in FIG. 1 for ease of illustration, but their support is assumed.

The wireless communication system 100, in one embodiment, includes an OAM/Management function 130. The OAM/Management function 130 may provide slice parameters (e.g., slice capabilities, slice policies, slice availability information, vertical to slice subscriptions and permissions, slice key performance indicators, slice service level agreements (“SLA”), and/or the like) to the enabler servers (e.g., EES 145). In various embodiments, the OAM/Management function 130 performs slice instantiation, e.g., in response to a request from a service provider.

As depicted, the data network 150 may include a vertical application layer (“VAL”) server 151, an application server 153 and/or a SEAL server 155. In 3GPP, an application support layer has been specified for vertical applications, known as vertical application enabler layer. Examples of vertical application enablers include the V2X enabler server, the FF enabler server, and the UAS enable server. The vertical application enabler layer may act as a distributed or centralized middleware, which may reside at the MNO or the 3rd party/vertical service provider's domain, for exposing northbound APIs to verticals as well as to provide some server-client support functionalities for the connected devices.

The Service Enabler Architecture Layer (“SEAL”) provides an enabler layer common for all verticals. SEAL comprises several server functionalities (e.g., Network Resource Management, Location Management, Configuration Management, Group Management, Identity Management, Key Management, Network Slice Enablement, and/or the like) as well as client functionalities at the end devices. SEAL also comprises AF functionality when interacting with 5G Core Network. The VAL server 151 is one embodiment of an enabler server or an application specific server, which consumes the services which are provided by the SEAL server functionalities and is communicatively coupled to the VAL client 108 on the remote unit 105. In some embodiments, the SEAL server 155 and/or enabler server reside at either the Data Network 150 or the Edge Data Network 141. In further embodiments, the SEAL server 155 and enabler server are co-located.

Also, there are two models: on-network and off-network models. In on-network model, the SEAL client 107 communicates with the SEAL server 155 over the SEAL-UU reference point, whereas for off-network the identity management client of the UE1 communicates with the SEAL client 107 of the UE2 over the SEAL-PC5 reference point.

Although specific numbers and types of network functions are depicted in FIG. 1, one of skill in the art will recognize that any number and type of network functions may be included in the mobile core network 120. Moreover, where the mobile core network 120 comprises an EPC, the depicted network functions may be replaced with appropriate EPC entities, such as a Mobility Management Entity (“MME”), Serving Gateway (“S-GW”), P-GW, Home Subscriber Server (“HSS”), and the like.

While FIG. 1 depicts components of a 5G RAN and a 5G core network, the described solutions apply to other types of communication networks and RATs, including IEEE 802.11 variants, GSM, GPRS, UMTS, LTE variants, CDMA 2000, Bluetooth, ZigBee, Sigfoxx, and the like. For example, in an LTE variant involving an EPC, the AMF 123 may be mapped to an MME, the SMF mapped to a control plane portion of a PGW and/or to an MME, the UPF map to an SGW and a user plane portion of the PGW, the UDM/UDR maps to an HSS, etc.

In one embodiment, a remote unit 105 (e.g., a UE) may connect to the mobile core network (e.g., to a 5G mobile communication network) 120 via two types of accesses: (1) via 3GPP access network and (2) via a non-3GPP access network. The first type of access (e.g., 3GPP access network) uses a 3GPP-defined type of wireless communication (e.g., NG-RAN) and the second type of access (e.g., non-3GPP access network) uses a non-3GPP-defined type of wireless communication (e.g., WLAN). The 5G-RAN refers to any type of 5G access network that can provide access to the mobile core network 120, including the 3GPP access network and the non-3GPP access network.

In the following descriptions, the term eNB/gNB is used for the base station but it is replaceable by any other radio access node, e.g., BS, eNB, gNB, AP, NR, etc. Further the operations are described mainly in the context of 5G NR. However, the proposed solutions/methods are also equally applicable to other mobile communication systems supporting middleware-assisted slice and/or DNN re-mapping for vertical applications and/or edge network deployments.

As background, regarding service requirements and use cases, location services are one type of service that can be provided by the mobile communication system. Such location-based services can serve certain vertical industries or can be provided for target applications.

Prior 5G, in 3GPP TS 22.071, some exemplary supported location-based services have been defined and the standardized service types have been discussed, including:
Emergency Services
Emergency Alert Services
Person Tracking
Fleet Management.
Asset Management
Traffic Congestion Reporting
Roadside Assistance
Routing to Nearest Commercial Enterprise
Traffic and public transportation information
City Sightseeing
Localized Advertising
Mobile Yellow Pages
Weather
Asset and Service Finding

Considering 5G use cases, in 3GPP Rel-17, the different positioning requirements are especially stringent with respect to accuracy, latency and reliability. Table 1 shows the positioning performance requirements for different scenarios in an industrial internet of things (“IIoT”) or indoor factory setting.

TABLE 1
IIoT Use Case Positioning Performance Requirements

| | | | | | | | Latency | | | |
|---|---|---|---|---|---|---|---|---|---|---|
| | | | | | | | for | | | Corresponding |
| | | | | | | | position | | | Positioning |
| | Horizontal | | Vertical | | | | estimation | | | Service Level |
| Scenario | accuracy | | accuracy | | Availability | Heading | of UE | | UE Speed | in TS 22.261 |
| Mobile control panels | <5 | m | <3 | m | 90% | N/A | <5 | s | N/A | Service Level 2 |
| with safety functions | | | | | | | | | | |
| (non-danger zones) | | | | | | | | | | |
| Process automation - | <1 | m | <3 | m | 90% | N/A | <2 | s | <30 km/h | Service Level 3 |
| plant asset | | | | | | | | | | |
| management | | | | | | | | | | |
| Flexible, modular | <1 m | | N/A | | 99% | N/A | 1 | s | <30 km/h | Service Level 3 |
| assembly area in smart | (relative | | | | | | | | | |
| factories (for tracking | positioning) | | | | | | | | | |
| of tools at the work- | | | | | | | | | | |
| place location) | | | | | | | | | | |
| Augmented reality in | <1 | m | <3 | m | 99% | <0.17 rad | <15 | ms | <10 km/h | Service Level 4 |
| smart factories | | | | | | | | | | |
| Mobile control panels | <1 | m | <3 | m | 99.9% | <0.54 rad | <1 | s | N/A | Service Level 4 |
| with safety functions | | | | | | | | | | |
| in smart factories | | | | | | | | | | |
| (within factory danger | | | | | | | | | | |
| zones) | | | | | | | | | | |
| Flexible, modular | <50 | cm | <3 | m | 99% | N/A | 1 | s | <30 km/h | Service Level 5 |
| assembly area in smart | | | | | | | | | | |
| factories (for | | | | | | | | | | |
| autonomous vehicles, | | | | | | | | | | |
| only for monitoring | | | | | | | | | | |
| proposes) | | | | | | | | | | |
| Inbound logistics for | <30 cm (if | | <3 | m | 99.9% | N/A | 10 | ms | <30 km/h | Service Level 6 |
| manufacturing (for | supported | | | | | | | | | |
| driving trajectories (if | by further | | | | | | | | | |
| supported by further | sensors | | | | | | | | | |
| sensors like camera, | like | | | | | | | | | |
| GNSS, IMU) of indoor | camera, | | | | | | | | | |
| autonomous driving | GNSS, | | | | | | | | | |
| systems)) | IMU) | | | | | | | | | |
| Inbound logistics for | <20 | cm | <20 | cm | 99% | N/A | <1 | s | <30 km/h | Service Level 7 |
| manufacturing (for | | | | | | | | | | |
| storage of goods) | | | | | | | | | | |

In one embodiment, the positioning service levels have been defined in TS 22.261 for the IIOT use cases, as shown below:

TABLE 2
Positioning Service Levels

| | | Accuracy | | | | | Coverage, environment of use and UE velocity | | |
|---|---|---|---|---|---|---|---|---|---|
| | | (95% | | | | | | 5G enhanced positioning service | |
| | | confidence | | | | | | area | |
| | Absolute(A) | level) | | | | | | (note 2) | |
| Positioning | or | | Vertical | Positioning | Positioning | | 5G | Outdoor | |
| service | Relative(R) | Horizontal | Accuracy | service | service | | positioning | and | |
| level | positioning | Accuracy | (note 1) | availability | latency | | service area | tunnels | Indoor |
| 1 | A | 10 m | 3 m | 95% | 1 | s | Indoor - up to | NA | Indoor - up to 30 |
| | | | | | | | 30 km/h | | km/h |
| | | | | | | | Outdoor | | |
| | | | | | | | (rural and | | |
| | | | | | | | urban) up to | | |
| | | | | | | | 250 km/h | | |
| 2 | A | 3 m | 3 m | 99% | 1 | s | Outdoor | Outdoor | Indoor - up to 30 |
| | | | | | | | (rural and | (dense | km/h |
| | | | | | | | urban) up to | urban) up to | |
| | | | | | | | 500 km/h for | 60 km/h | |
| | | | | | | | trains and up | Along roads | |
| | | | | | | | to 250 km/h | up to 250 | |
| | | | | | | | for other | km/h and | |
| | | | | | | | vehicles | along | |
| | | | | | | | | railways up | |
| | | | | | | | | to 500 km/h | |
| 3 | A | 1 m | 2 m | 99% | 1 | s | Outdoor | Outdoor | Indoor - up to 30 |
| | | | | | | | (rural and | (dense | km/h |
| | | | | | | | urban) up to | urban) up to | |
| | | | | | | | 500 km/h for | 60 km/h | |
| | | | | | | | trains and up | Along roads | |
| | | | | | | | to 250 km/h | up to 250 | |
| | | | | | | | for other | km/h and | |
| | | | | | | | vehicles | along | |
| | | | | | | | | railways up | |
| | | | | | | | | to 500 km/h | |
| 4 | A | 1 m | 2 m | 99.9% | 15 | ms | NA | NA | Indoor - up to 30 |
| | | | | | | | | | km/h |
| 5 | A | 0.3 m | 2 m | 99% | 1 | s | Outdoor | Outdoor | Indoor - up to 30 |
| | | | | | | | (rural) up to | (dense | km/h |
| | | | | | | | 250 km/h | urban) up to | |
| | | | | | | | | 60 km/h | |
| | | | | | | | | Along roads | |
| | | | | | | | | and along | |
| | | | | | | | | railways up | |
| | | | | | | | | to 250 km/h | |
| 6 | A | 0.3 m | 2 m | 99.9% | 10 | ms | NA | Outdoor | Indoor - up to 30 |
| | | | | | | | | (dense | km/h |
| | | | | | | | | urban) up to | |
| | | | | | | | | 60 km/h | |

| | | | | | | | |
|---|---|---|---|---|---|---|---|
| 7 | R | 0.2 m | 0.2 m | 99% | 1 | s | Indoor and outdoor (rural, urban, |
| | | | | | | | dense urban) up to 30 km/h |
| | | | | | | | Relative positioning is between two UEs within |
| | | | | | | | 10 m of each other or between one UE and 5G |
| | | | | | | | positioning nodes within |
| | | | | | | | 10 m of each other (note 3) |

NOTE 1: The objective for the vertical positioning requirement is to determine the floor for indoor use cases and to distinguish between superposed tracks for road and rail use cases (e.g., bridges).
NOTE 2: Indoor includes location inside buildings such as offices, hospital, industrial buildings.
NOTE 3: 5G positioning nodes are infrastructure equipment deployed in the service area to enhance positioning capabilities (e.g., beacons deployed on the perimeter of a rendezvous area or on the side of a warehouse).

Regarding positioning methods and technologies, in one embodiment, to meet the above location service requirement, different positioning techniques have been specified in Rel-16. The following RAT-dependent positioning techniques are supported in Rel-16:

DL-TDoA—The DL-TDOA positioning method makes use of the DL RSTD (and optionally DL PRS RSRP) of downlink signals received from multiple TPs, at the UE. The UE measures the DL RSTD (and optionally DL PRS RSRP) of the received signals using assistance data received from the positioning server, and the resulting measurements are used along with other configuration information to locate the UE in relation to the neighboring TPs.

DL-AoD—The DL AoD positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

Multi-RTT—The Multi-RTT positioning method makes use of the UE Rx-Tx measurements and DL PRS RSRP of downlink signals received from multiple TRPs, measured by the UE and the measured gNB Rx-Tx measurements and UL SRS-RSRP at multiple TRPs of uplink signals transmitted from UE.

The UE measures the UE Rx-Tx measurements (and optionally DL PRS RSRP of the received signals) using assistance data received from the positioning server, and the TRPs measure the gNB Rx-Tx measurements (and optionally UL SRS-RSRP of the received signals) using assistance data received from the positioning server. The measurements are used to determine the RTT at the positioning server which are used to estimate the location of the UE.

E-CID/NR E-CID-Enhanced Cell ID (CID) positioning method, the position of a UE is estimated with the knowledge of its serving ng-eNB, gNB and cell and is based on LTE signals. The information about the serving ng-eNB, gNB and cell may be obtained by paging, registration, or other methods. NR Enhanced Cell ID (NR E CID) positioning refers to techniques which use additional UE measurements and/or NR radio resource and other measurements to improve the UE location estimate using NR signals.

Although NR E-CID positioning may utilize some of the same measurements as the measurement control system in the RRC protocol, the UE generally is not expected to make additional measurements for the sole purpose of positioning; i.e., the positioning procedures do not supply a measurement configuration or measurement control message, and the UE reports the measurements that it has available rather than being required to take additional measurement actions.

UL-TDoA—The UL TDOA positioning method makes use of the UL TDOA (and optionally UL SRS-RSRP) at multiple RPs of uplink signals transmitted from UE. The RPs measure the UL TDOA (and optionally UL SRS-RSRP) of the received signals using assistance data received from the positioning server, and the resulting measurements are used along with other configuration information to estimate the location of the UE.

UL-AoA—The UL AoA positioning method makes use of the measured azimuth and the zenith of arrival at multiple RPs of uplink signals transmitted from UE. The RPs measure A-AoA and Z-AoA of the received signals using assistance data received from the positioning server, and the resulting measurements are used along with other configuration information to estimate the location of the UE.

In one embodiment, these methods make use of UEs that are equipped with radio receivers capable of receiving global navigation satellite system (“GNSS”) signals. In 3GPP specifications, the term GNSS encompasses both global and regional/augmentation navigation satellite systems.

Examples of global navigation satellite systems include global positioning system (“GPS”), Modernized GPS, Galileo, GLONASS, and BeiDou Navigation Satellite System (“BDS”). Regional navigation satellite systems include Quasi Zenith Satellite System (“QZSS”) while the many augmentation systems, are classified under the generic term of Space Based Augmentation Systems (“SBAS”) and provide regional augmentation services.

In this concept, different GNSSs (e.g., GPS, Galileo, etc.) can be used separately or in combination to determine the location of a UE.

In one embodiment, a barometric pressure sensor method makes use of barometric sensors to determine the vertical component of the position of the UE. The UE measures barometric pressure, optionally aided by assistance data, to calculate the vertical component of its location or to send measurements to the positioning server for position calculation. This method may be combined with other positioning methods to determine the 3D position of the UE.

In one embodiment, a wireless local area network (“WLAN”) positioning method makes use of the WLAN measurements (e.g., AP identifiers and optionally other measurements) and databases to determine the location of the UE. The UE measures received signals from WLAN access points, optionally aided by assistance data, to send measurements to the positioning server for position calculation. Using the measurement results and a references database, the location of the UE is calculated. Alternatively, the UE makes use of WLAN measurements and optionally WLAN AP assistance data provided by the positioning server, to determine its location.

In one embodiment, a Bluetooth positioning method makes use of Bluetooth measurements (e.g., beacon identifiers and optionally other measurements) to determine the location of the UE. The UE measures received signals from Bluetooth beacons. Using the measurement results and a references database, the location of the UE is calculated. The Bluetooth methods may be combined with other positioning methods (e.g., WLAN) to improve positioning accuracy of the UE.

In one embodiment, a Terrestrial Beacon System (“TBS”) consists of a network of ground-based transmitters, broadcasting signals only for positioning purposes. One type of TBS positioning signals are the Metropolitan Beacon System (“MBS”) signals and Positioning Reference Signals (“PRS”). The UE measures received TBS signals, optionally aided by assistance data, to calculate its location or to send measurements to the positioning server for position calculation.

In one embodiment, a motion sensor method makes use of different sensors such as accelerometers, gyros, magnetometers, to calculate the displacement of UE. The UE estimates a relative displacement based upon a reference position and/or reference time. UE sends a report comprising the determined relative displacement which can be used to determine the absolute position. This method should be used with other positioning methods for hybrid positioning.

Regarding location exposure background, in 3GPP, mainly SA2 and SA6 are the groups that discuss the LCS exposure. In SA2 (see 3GPP TS 23.273), location service can be exposed to the authorized control plane NF or the LCS client to obtain the UE location to enable their application and services using the mobile terminal location request (“MT-LR”) procedure. For the location service exposed to the AF which is not allowed to directly interact with the gateway mobile location centre (“GMLC”) or AMF, common API framework (“CAPIF”) API may be used between NEF and the AF as described in clause 6.2.5.1 of TS 23.501. For an AF not allowed to directly interact with the GMLC or AMF, the LCS service request is sent to NEF using the service-based interface. To support location service exposure through NEF, when NEF receives an LCS service request, it determines based on the location accuracy of the QoS requirement, e.g., lower or higher than cell-ID level, on whether to invoke the GMLC service or the AMF service for the LCS service request.

In SA6, SEAL has been specifying a Location Management (“LM”) layer. SEAL LM layer provides support for vertical industries (however, the actual use of SEAL LM layer is being specified in relevant vertical-specific SA6 studies). LM server is a functional entity that receives and stores user location information and provides user location information to the vertical application server. The location management server may also acquire location information provided by PLMN operator via T8 reference point. The location management server acts as CAPIF's API exposing function as specified in 3GPP TS 23.222. The location management server also supports interactions with the corresponding location management server in distributed SEAL deployments.

LM client acts as the application client for location management functions. It interacts with the location management server. The location management client also supports interactions with the corresponding location management client between the two UEs. There are two architecture options for on-network and off-network support.

In an on-network functional model, the LM client communicates with the LM server over the LM-UU reference point. The LM client provides the support for LM functions to the VAL client(s) over LM-C reference point. The VAL server(s) communicate with the LM server over the LM-S reference point. The LM server communicates with the service capability exposure function (“SCEF”) via T8 reference point to obtain location information from the underlying 3GPP network system. In one embodiment, VAL server can be the application specific server (e.g., Platooning server) or vertical specific enabler server (e.g., VAE).

For off-network functional model, the LM client of the UE1 communicates with the LM client of the UE2 over the LM-PC5 reference point. Furthermore, in EDGEAPP (see 3GPP TS 23.558) scenarios, one key API to be exposed to the edge application is the Location API. The edge enabler layer (“EEL”) may provide value-added services when exposing such information to the edge servers. TS 23.558 is specifying the Location API, which is provided by the EEL to the edge application servers. More specifically, the Edge Enabler Server exposes the UE location API to the Edge Application Server in order to support tracking or checking the valid location of the UE. The UE location API exposed by the Edge Enabler Server relies on the 3GPP core network capabilities. The Edge Application Server can request UE location API for one-time reporting to check current UE location and for continuous reporting to track UE's location. The UE location API supports both request-response for one-time queries (in order to check UE's current location) as well as subscribe-notify models for providing UE's location to EAS on a continuous basis and enabling the EAS to track UE's location (as UE location changes).

Furthermore, in 3GPP Release 18, a new SA6 study on 5G-enabled fused location service capability exposure (see TR 23.700-96) studies and evaluates the application architecture aspects and solutions to address potential new and enhanced location capabilities for vertical application enabler, including the following aspects:
Enabling location performance (accuracy, availability, and latency) enhancements through combined use and fusion of 3GPP and non-3GPP location technologies at the application layer;
Enabling continuity of location services in different environments at the application layer;
Identification and configuration of location related requirements (including location QoS) for vertical application services with the use of SA2-defined mechanisms; and
Enabling value-added location service capabilities exposure to vertical applications.

One of the identified Key Issues in TR 23.700-96 is, according to 3GPP TS 23.273 and 3GPP TS 23.071, the LCS QOS which is characterised by LCS QoS Class, Accuracy and Response Time may be required by the application (e.g., LCS client) for location requests. For certain LCS services the LCS QoS Class is non-negotiable.

In general, the solution proposed herein includes the following steps:

In step 1, in one embodiment, a VAL server makes a request (or subscribes) to ADAES for location measurement accuracy analytics, which may include one or more analytics events identifiers, one or more analytics types identifiers, predictions, stats, and/or sustainability parameters or indications, for a given VAL application for a given time horizon or area or a UE route.

In one embodiment, different types of analytics outputs can be within the same analytics type (but may be using different analytics event identifiers) and a parameter indicating the type of request may be provided. For example, the location accuracy prediction request can be in form of predicting the predictive location accuracy downgrade or upgrade in a given area, or for location accuracy predictions for a given location. In a further embodiment, the request may also include an expected UE route (or set of waypoints) per UE within the application and may ask analytics on the predictive location accuracy for the expected routes. In one embodiment, the request may comprise a requirement from the consumer to identify how accurately the arrival of the UE at the expected waypoints can be predicted at given time instances.

The request may also indicate whether location fusion is required. This request may also provide the permissions or restrictions of the VAL server to use LCS services from different LCS producers, e.g., LMF, SEAL, and/or the like, and their priorities. Also, the subscription may include a timer as a maximum time for attempting to collect/combine location reports for reaching a certain accuracy. In one embodiment, a minimum acceptable confidence level for the VAL application (e.g., which can be a service consisting of a group of UEs) is provided from the consumer to ADAES at this step.

In step 2, in one embodiment, the ADAES authorizes the request and discovers the relevant NWDAF and (acting as AF/NWDAF consumer), subscribes to the NWDAF to receive Location Accuracy analytics. If the NWDAF feature is not available or supported in the target area, in one embodiment, the ADAES skips steps 3-4, below, and performs its own location accuracy analytics.

In step 3, in one embodiment, the ADAES requests or receives location accuracy analytics reports for the target UE(s) of the VAL application (e.g., based on the VAL application ID and optionally the UE ID, e.g., general public subscription identifier (“GPSI”)) or for all the UEs in a target area or zone. These requests can be aggregated or can be provided per UE of the application. The location accuracy analytics reports may include a confidence level for the accuracy. In one embodiment, it is assumed that this is a minimum acceptable confidence level that is agreed between the NWDAF and the consumer or ADAES. This may be different from the confidence level agreed in step 1.

In step 4, in one embodiment, the ADAES checks the location accuracy analytics confidence level and, if there is need to improve the confidence level, subscribes to the one or more LCS producers (e.g., LMF and SEAL LMS) based on the priorities.

In step 5, in one embodiment, the ADAES sends one or more requests to one or more LCS producers (e.g., SEAL LMS, LMF, and/or the like) to acquire a location report for the target UE(s) of the VAL application.

In step 6, in one embodiment, the ADAES, in response to step 3, receives the location report from the LCS producers for the target UE(s) and the achieved accuracy.

Optionally, in step 7, in one embodiment, the ADAES uses the Fused Location Enabler (“FLE”) service (e.g., via Fused Location Client (“FLC”) APIs) to combine the location reports as received in step 6 and derives a new location accuracy, if fused location is used.

In step 8, in one embodiment, the ADAES uses the location accuracy of the combined reports, or the location accuracies per LCS producer if location fusion is not used, to be used as input to improve the location accuracy analytics which were provided by NWDAF.

In step 9, in one embodiment, the ADAES checks, based on the analytics event ID and the type of request (e.g. based on the analytics type indication) as in step 1, if the updated location accuracy analytics have improved or are at an acceptable confidence level for the VAL application, or whether these can be upgraded and become more granular (e.g., from meter to decimetre), or a location accuracy downgrade is expected.

In step 10, in one embodiment, if the location accuracy analytics have acceptable confidence level or have improved granularity based on the VAL server request, the ADAES provides the location accuracy analytics report to the VAL server. For example, the ADAES can provide the accuracy of a location as X %, that the target accuracy is sustainable, what the minimum-maximum accuracy along the route is, that a location accuracy upgrade is possible, that a location accuracy downgrade is expected for location X, report on the high-accuracy set of waypoints to be used within the UE route, and/or the like.

The following embodiments aim to capture different implementations for location accuracy prediction and/or sustainability for a target location, and location accuracy prediction based on the UE route or waypoints.

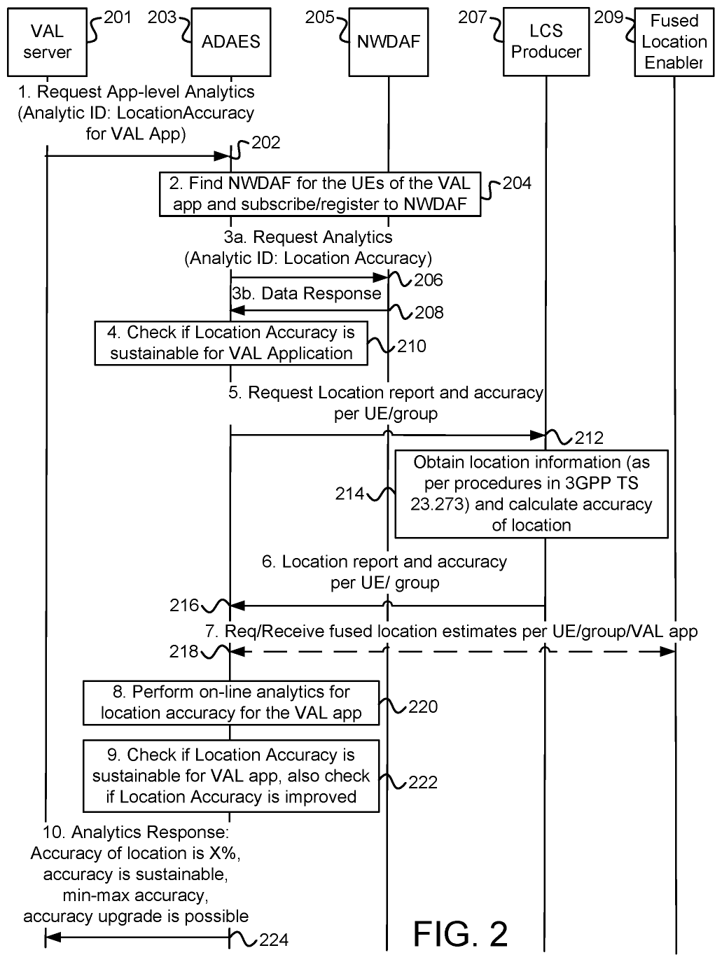

FIG. 2 depicts a procedure flow for one embodiment to derive analytics for location accuracy. In one embodiment, at step 1, a VAL server 201 makes a request (or subscribes) (see messaging 202) to the ADAES 203 for location accuracy prediction or stats, including an analytics event ID (e.g., “location accuracy prediction” or “location accuracy sustainability”), an analytics request type (if not identified specifically at the event ID), which can be the location accuracy prediction for a given location X and/or for a given UE or application. The request may include a target area; a target VAL application, a VAL UE, a group of UEs, a service type, and/or the like; a time of day; an accuracy threshold and requirements (which may be provided at the application requirement/first request); and a minimum confidence level threshold.

At step 2, in one embodiment, the ADAES 203 discovers (see block 204) the NWDAF 205 to provide location accuracy analytics. At step 3a, in one embodiment, the ADAES 203 subscribes (see messaging 206) for receiving location accuracy analytics. At step 3b, in one embodiment, the ADAES 203 receives (see messaging 208) location accuracy analytics for the target location and/or per UE.

At step 4, in one embodiment, the ADAES 203 checks (see block 210) whether location accuracy prediction or sustainability received from the thee NWDAF 205, addresses the request and especially checks whether the location accuracy prediction for a given location satisfies the requirements for the VAL application (may comprise of multiple UEs), whether the confidence level of the prediction addresses the min confidence level of the VAL application request, and/or whether the location accuracy requirement needs to be upgraded or downgraded based on the report. Note that if the NWDAF 205 feature is not supported or available, steps 3-4 may be omitted.

At step 5, in on embodiment, the ADAES 203 performs a location request (see messaging 212) to an LCS producer 207 that obtains location information and calculates accuracy of location (see block 214). The LCS producer 207 may include one or more of:
a SEAL LMS, acting as VAL server 201, to request the location information for one or more UEs (VAL triggered location reporting trigger). This report can also be performed for all UEs within a given area. Such a request may provide a request for reporting the location accuracy for the target location report that corresponds to a UE, a UE group, a service, or an area;
an LMF/GMLC directly or via NEF (see, e.g., TS 23.273), acting as AF. The LCS service request is sent to GMLC/LMF or AMF, via NEF, using the service-based interface, CAPIF API, or directly to GMLC if allowed (e.g., LSE-S within MNO trust domain). Such request may provide a request for reporting the location accuracy for the target location report that corresponds to a UE, a UE group, a service, or an area;
a RAN/RAN-LMC. This request can be sent to a RAN function that computes the location for one or more UEs. Such request may include the application ID, location QoS requirements (e.g., absolute and relative horizontal and vertical accuracies, response time, and/or the like), positioning method(s) and priorities related to positioning methods and associated positioning measurements, number of positioning fixes of a particular UE, and/or integrity of the positioning estimate, e.g., confidence interval, alert limits, time-to-alert, target and integrity risk. Such a request may provide a request for reporting the location accuracy for the target location report that corresponds to a UE, a UE group, a service, or an area;
a MEC platform via invoking a Location API. This request may be enhanced to include the LCS profile ID and configuration information (e.g., if MEC capability is not aware of the profiles). Such a request may provide a request for reporting the location accuracy for the target location report which corresponds to a UE, a UE group, a service, or an area; and
A third party location service producer or non-3GPP network. This can be provided 1) via application layer or 2) as indicated in UE Assisted and UE Based Positioning procedure in clause 6.11.1 of TS 23.273, via N3IWF/TNGF/wireline access gateway function (“W-AGF”), or 3) as indicated in network assisted positioning procedure in clause 6.11.2 of TS 23.273, via N3IWF/TNGF/W-AGF.

At step 6, in one embodiment, the ADAES 203 receives (see messaging 216) a location response (including a location report) from the requested entities in step 5, which provides the location information or estimate based on the requested granularity (e.g., coordinates, cell level, civic address, and/or the like), a timestamp, the triggering event (e.g., if the request is about sending a location report only in case of an event), whether it is actual or predicted location of the UE(s), and/or an associated confidence interval or related metric indicating the reliability of the provided location estimate. Such a response may also include the location accuracy for the target location report which corresponds to a UE, a UE group, a service, or an area.

At step 7, in one embodiment, the ADAES 203 may optionally request and receive (see messaging 218) a fused location estimate from a fused location server 209 (e.g., discussed in 3GPP TR 23.700-96). This estimate may also include the location accuracy for the target location fused location report which corresponds to a UE, a UE group, a service, or an area.

At step 8, in one embodiment, the ADAES 203 performs (see block 220) on-line analytics for deriving the predicted location accuracy for the VAL application, using a pre-defined analytics method for the event (e.g., regression or machine learning/artificial intelligence).

At step 9, in one embodiment, the ADAES 203 checks (see block 222), based on the derived analytics for the analytics event ID and the type of request as in step 1, if the updated location accuracy analytics have improved or acceptable confidence levels for the VAL application, or whether these can be upgraded and become more granular (e.g., from meter to decimeter) or whether a location accuracy downgrade is expected.

At step 10, in one embodiment, the ADAES 203, if the location accuracy analytics have acceptable confidence level or have improved granularity based on the VAL server request, provides (see messaging 224) the location accuracy analytics report to the VAL server 201. For example, the ADAES 203 may determine that the accuracy of location is X %, that the target accuracy is sustainable, the min-max accuracy along the route, that a location accuracy upgrade is possible, and/or that a location accuracy downgrade is expected for location X.

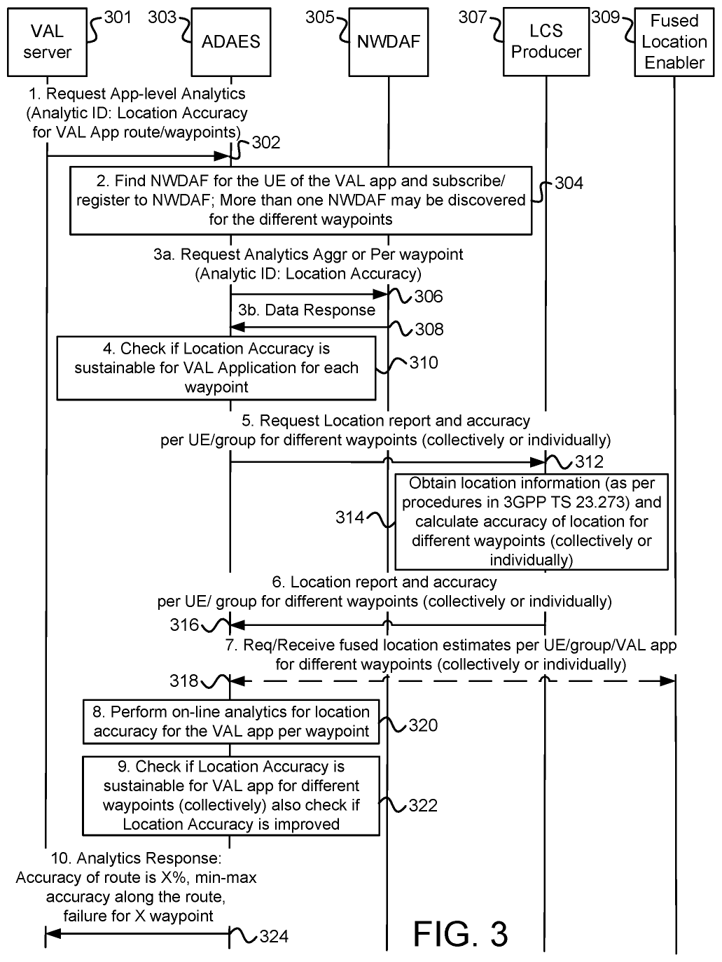

FIG. 3 depicts a procedure flow for one embodiment to derive analytics for location accuracy for an expected UE route. In one embodiment, the procedure in FIG. 3 shares similarities with the procedure in FIG. 2. The main differences are discussed below.

In one embodiment, at step 1, VAL server 301 sends (see messaging 302) the UE route or set of waypoints to the ADAES 303 by the consumer, for one or more UEs or for the application or service (e.g., route of a platoon). Also, in one embodiment, the subscription request may include the type of analytics request (e.g., the per UE route accuracy, the per VAL application and route accuracy for a group of UEs within the application, a failure to meet accuracy for certain waypoints, the min-max accuracy, the possibility of upgrade, and/or the like).

At step 2, in one embodiment, more than one NWDAF 305 can be discovered (see block 304) with the route for different location waypoints.

At step 3a and 3b, in one embodiment, the request (see messaging 306) and response (see messaging 308) to NWDAF 305 may not be only for one location but for multiple locations. In one embodiment, it could be separate requests or aggregated requests for the locations or UEs within the NWDAF 305 coverage.

At step 4, in one embodiment, the ADAES 303 checks (see block 310) if location accuracy is sustainable for VAL Application for each waypoint.

At steps 5-7, in one embodiment, location requests or reports may be aggregated for all waypoints or separately provided (see messaging 312, 314, 316, 318).

At step 8, in one embodiment, the ADAES 303 performs (see block 320) the online analytics per waypoint of the route (or could also be done per route per UE).

At step 9, in one embodiment, the ADAES 303 checks (see block 322) if location accuracy is sustainable for a VAL application and/or per UE route for different waypoints (collectively) and also checks if location accuracy is improved.

At step 10, in one embodiment, the ADAES 303 provides (see messaging 324)) the output to the VAL server 301 and may include the per UE route accuracy, the per VAL application and route accuracy for a group of UEs within the application, a failure to meet accuracy for certain waypoints, the min-max accuracy, the possibility of upgrade, and/or the like. Also, possible downgrade in certain parts of the route based on the failure to meet certain accuracy in one or more waypoints may be provided.

The analytics output to the consumer may include at least one of the following:

TABLE 3
“Location Measurement Accuracy” analytics

| | Mandatory/Optional/ | |
|---|---|---|
| | Conditionally | |
| Information | Mandatory | Description |
| VAL Application ID | M(NOTE) | The ID of the target VAL application for which the |
| | | analytics apply |
| VAL group ID | M(NOTE) | The ID of the target group of UEs for which the analytics |
| | | apply |
| VAL UE ID and | M(NOTE) | The ID and IP address of the target VAL UE (e.g., GSPI) |
| address | | for which the analytics apply |
| Applicable Area | M | A list of service areas (edge service area, or topological |
| | | areas, or coordinates) within the Location information that |
| | | the analytics applies to. |
| Applicable Time | M | The time period within the Analytics target period that the |
| Period | | analytics applies to. |
| Type of analytics ID | O | The analytics type that is provided based on the request. |
| | | Can be one from predictive location accuracy |
| | | sustainability indication, a predictive location accuracy |
| | | change indication, a predictive location accuracy |
| | | sustainability and/or change indication for a route of the |
| | | one or more UEs within the application |
| Route | O | A route of the UE where accuracy of location is estimated |
| Percentage of | M | A percentage indicating if the requested analytics |
| analytics accuracy | | accuracy is met |
| above/below | | |
| requested thresholds | | |
| Confidence level | M | Confidence for the prediction |
| Fused Location flag | O | Whether fused location service has been used |
| Predictive Location | O | A prediction for a UE of the application based on the |
| Accuracy Upgrade/ | | location analytics for possible downgrade or upgrade of |
| Downgrade indication | | location accuracy with a given time horizon |
| > VAL UE UD | CM | The UE for which the upgrade/downgrade applies |
| > time horizon | CM | The time for which this is predicted (can be within the |
| | | applicable time period) |
| > location estimate | CM | The location estimates for the UE |
| > predicted accuracy/ | CM | The predicted accuracy/QoS of the location estimate |
| QoS of expected | | |
| location estimate | | |
| > recommendation of | O | For the case of prescriptive analytics, to provide the |
| application operation/ | | recommended change of service mode (e.g., automation |
| mode change | | level) or application behaviour to deal with a possible |
| | | downgrade/upgrade of location accuracy |

NOTE:
at least one of these IDs shall be present

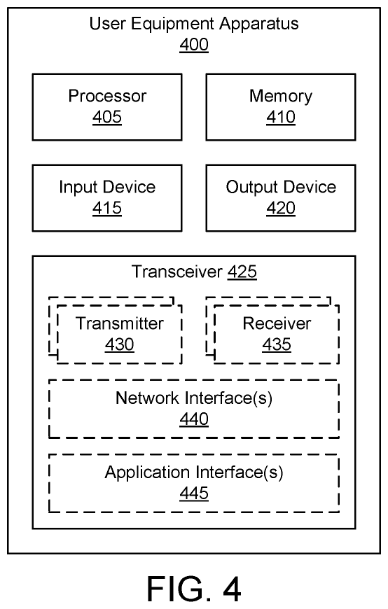

FIG. 4 depicts a user equipment apparatus 400 that may be used for location accuracy prediction at application data analytics enabler, according to embodiments of the disclosure. In various embodiments, the user equipment apparatus 400 is used to implement one or more of the solutions described above. The user equipment apparatus 400 may be one embodiment of the remote unit 105 and/or the UE, described above. Furthermore, the user equipment apparatus 400 may include a processor 405, a memory 410, an input device 415, an output device 420, and a transceiver 425.

In some embodiments, the input device 415 and the output device 420 are combined into a single device, such as a touchscreen. In certain embodiments, the user equipment apparatus 400 may not include any input device 415 and/or output device 420. In various embodiments, the user equipment apparatus 400 may include one or more of: the processor 405, the memory 410, and the transceiver 425, and may not include the input device 415 and/or the output device 420.

As depicted, the transceiver 425 includes at least one transmitter 430 and at least one receiver 435. In some embodiments, the transceiver 425 communicates with one or more cells (or wireless coverage areas) supported by one or more base units 121. In various embodiments, the transceiver 425 is operable on unlicensed spectrum. Moreover, the transceiver 425 may include multiple UE panel supporting one or more beams. Additionally, the transceiver 425 may support at least one network interface 440 and/or application interface 445. The application interface(s) 445 may support one or more APIs. The network interface(s) 440 may support 3GPP reference points, such as Uu, N1, PC5, etc. Other network interfaces 440 may be supported, as understood by one of ordinary skill in the art.

The processor 405, in one embodiment, may include any known controller capable of executing computer-readable instructions and/or capable of performing logical operations. For example, the processor 405 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 405 executes instructions stored in the memory 410 to perform the methods and routines described herein. The processor 405 is communicatively coupled to the memory 410, the input device 415, the output device 420, and the transceiver 425. In certain embodiments, the processor 405 may include an application processor (also known as “main processor”) which manages application-domain and operating system (“OS”) functions and a baseband processor (also known as “baseband radio processor”) which manages radio functions.

In various embodiments, the processor 405 and transceiver 425 control the user equipment apparatus 400 to implement the above described UE behaviors. The memory 410, in one embodiment, is a computer readable storage medium. In some embodiments, the memory 410 includes volatile computer storage media. For example, the memory 410 may include a RAM, including dynamic RAM (“DRAM”), synchronous dynamic RAM (“SDRAM”), and/or static RAM (“SRAM”). In some embodiments, the memory 410 includes non-volatile computer storage media. For example, the memory 410 may include a hard disk drive, a flash memory, or any other suitable non-volatile computer storage device. In some embodiments, the memory 410 includes both volatile and non-volatile computer storage media.

In some embodiments, the memory 410 stores data related to location accuracy prediction at application data analytics enabler. For example, the memory 410 may store various parameters, panel/beam configurations, resource assignments, policies, and the like as described above. In certain embodiments, the memory 410 also stores program code and related data, such as an operating system or other controller algorithms operating on the user equipment apparatus 400.

The input device 415, in one embodiment, may include any known computer input device including a touch panel, a button, a keyboard, a stylus, a microphone, or the like. In some embodiments, the input device 415 may be integrated with the output device 420, for example, as a touchscreen or similar touch-sensitive display. In some embodiments, the input device 415 includes a touchscreen such that text may be input using a virtual keyboard displayed on the touchscreen and/or by handwriting on the touchscreen. In some embodiments, the input device 415 includes two or more different devices, such as a keyboard and a touch panel.

The output device 420, in one embodiment, is designed to output visual, audible, and/or haptic signals. In some embodiments, the output device 420 includes an electronically controllable display or display device capable of outputting visual data to a user. For example, the output device 420 may include, but is not limited to, an LCD display, an LED display, an OLED display, a projector, or similar display device capable of outputting images, text, or the like to a user. As another, non-limiting, example, the output device 420 may include a wearable display separate from, but communicatively coupled to, the rest of the user equipment apparatus 400, such as a smart watch, smart glasses, a heads-up display, or the like. Further, the output device 420 may be a component of a smart phone, a personal digital assistant, a television, a table computer, a notebook (laptop) computer, a personal computer, a vehicle dashboard, or the like.

In certain embodiments, the output device 420 includes one or more speakers for producing sound. For example, the output device 420 may produce an audible alert or notification (e.g., a beep or chime). In some embodiments, the output device 420 includes one or more haptic devices for producing vibrations, motion, or other haptic feedback. In some embodiments, all, or portions of the output device 420 may be integrated with the input device 415. For example, the input device 415 and output device 420 may form a touchscreen or similar touch-sensitive display. In other embodiments, the output device 420 may be located near the input device 415.

The transceiver 425 communicates with one or more network functions of a mobile communication network via one or more access networks. The transceiver 425 operates under the control of the processor 405 to transmit messages, data, and other signals and also to receive messages, data, and other signals. For example, the processor 405 may selectively activate the transceiver 425 (or portions thereof) at particular times in order to send and receive messages.

The transceiver 425 includes at least transmitter 430 and at least one receiver 435. One or more transmitters 430 may be used to provide UL communication signals to a base unit 121, such as the UL transmissions described herein. Similarly, one or more receivers 435 may be used to receive DL communication signals from the base unit 121, as described herein. Although only one transmitter 430 and one receiver 435 are illustrated, the user equipment apparatus 400 may have any suitable number of transmitters 430 and receivers 435. Further, the transmitter(s) 430 and the receiver(s) 435 may be any suitable type of transmitters and receivers. In one embodiment, the transceiver 425 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 425, transmitters 430, and receivers 435 may be implemented as physically separate components that access a shared hardware resource and/or software resource, such as for example, the network interface 440.

In various embodiments, one or more transmitters 430 and/or one or more receivers 435 may be implemented and/or integrated into a single hardware component, such as a multi-transceiver chip, a system-on-a-chip, an ASIC, or other type of hardware component. In certain embodiments, one or more transmitters 430 and/or one or more receivers 435 may be implemented and/or integrated into a multi-chip module. In some embodiments, other components such as the network interface 440 or other hardware components/circuits may be integrated with any number of transmitters 430 and/or receivers 435 into a single chip. In such embodiment, the transmitters 430 and receivers 435 may be logically configured as a transceiver 425 that uses one more common control signals or as modular transmitters 430 and receivers 435 implemented in the same hardware chip or in a multi-chip module.

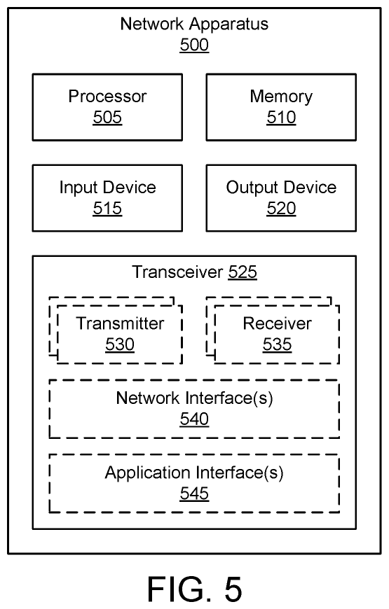

FIG. 5 depicts a network apparatus 500 that may be used for location accuracy prediction at application data analytics enabler, according to embodiments of the disclosure. In one embodiment, network apparatus 500 may be one implementation of a RAN node, such as the base unit 121, the RAN node 210, or gNB, described above. Furthermore, the base network apparatus 500 may include a processor 505, a memory 510, an input device 515, an output device 520, and a transceiver 525.

In some embodiments, the input device 515 and the output device 520 are combined into a single device, such as a touchscreen. In certain embodiments, the network apparatus 500 may not include any input device 515 and/or output device 520. In various embodiments, the network apparatus 500 may include one or more of: the processor 505, the memory 510, and the transceiver 525, and may not include the input device 515 and/or the output device 520.

As depicted, the transceiver 525 includes at least one transmitter 530 and at least one receiver 535. Here, the transceiver 525 communicates with one or more remote units 105. Additionally, the transceiver 525 may support at least one network interface 540 and/or application interface 545. The application interface(s) 545 may support one or more APIs. The network interface(s) 540 may support 3GPP reference points, such as Uu, N1, N2 and N3. Other network interfaces 540 may be supported, as understood by one of ordinary skill in the art.

The processor 505, in one embodiment, may include any known controller capable of executing computer-readable instructions and/or capable of performing logical operations. For example, the processor 505 may be a microcontroller, a microprocessor, a CPU, a GPU, an auxiliary processing unit, a FPGA, or similar programmable controller. In some embodiments, the processor 505 executes instructions stored in the memory 510 to perform the methods and routines described herein. The processor 505 is communicatively coupled to the memory 510, the input device 515, the output device 520, and the transceiver 525. In certain embodiments, the processor 505 may include an application processor (also known as “main processor”) which manages application-domain and operating system (“OS”) functions and a baseband processor (also known as “baseband radio processor”) which manages radio function.

The memory 510, in one embodiment, is a computer readable storage medium. In some embodiments, the memory 510 includes volatile computer storage media. For example, the memory 510 may include a RAM, including dynamic RAM (“DRAM”), synchronous dynamic RAM (“SDRAM”), and/or static RAM (“SRAM”). In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media.

In some embodiments, the memory 510 stores data related to location accuracy prediction at application data analytics enabler. For example, the memory 510 may store parameters, configurations, resource assignments, policies, and the like, as described above. In certain embodiments, the memory 510 also stores program code and related data, such as an operating system or other controller algorithms operating on the network apparatus 500.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, is designed to output visual, audible, and/or haptic signals. In some embodiments, the output device 520 includes an electronically controllable display or display device capable of outputting visual data to a user. For example, the output device 520 may include, but is not limited to, an LCD display, an LED display, an OLED display, a projector, or similar display device capable of outputting images, text, or the like to a user. As another, non-limiting, example, the output device 520 may include a wearable display separate from, but communicatively coupled to, the rest of the network apparatus 500, such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all, or portions of the output device 520 may be integrated with the input device 515. For example, the input device 515 and output device 520 may form a touchscreen or similar touch-sensitive display. In other embodiments, the output device 520 may be located near the input device 515.

The transceiver 525 includes at least transmitter 530 and at least one receiver 535. One or more transmitters 530 may be used to communicate with the UE, as described herein. Similarly, one or more receivers 535 may be used to communicate with network functions in the non-public network (“NPN”), PLMN and/or RAN, as described herein. Although only one transmitter 530 and one receiver 535 are illustrated, the network apparatus 500 may have any suitable number of transmitters 530 and receivers 535. Further, the transmitter(s) 530 and the receiver(s) 535 may be any suitable type of transmitters and receivers.

In one embodiment, the transceiver 525 receives a first analytics parameter associated with a location measurement for a user equipment (“UE”) device. In one embodiment, the processor 505 derives application layer analytics for location measurement accuracy for a target application of the UE, based on the first analytics parameter, and location accuracy measurements from at least one location service producer and determines a second analytics parameter indicating a predictive adaptation of a location measurement accuracy in response to deriving the application layer analytics based on an application requirement of the target application.

In one embodiment, the second analytics parameter comprises at least one of a predictive location accuracy sustainability indication, a predictive location accuracy change indication, a predictive location accuracy sustainability indication for a route of the UE with the application, and a predictive location accuracy change indication for a route of the UE with the application.

In one embodiment, the processor 505 prescribes at least one of an application service operation and a behavior change based on the predictive location accuracy change. In one embodiment, the transceiver 525 receives a first request comprising the application requirement of the target application from an external application for providing predictions for an accuracy of a location measurement for the target application of the UE.

In one embodiment, the processor 505 identifies an area of interest with a predefined minimum location accuracy for a given time of day based on at least one of the first and the second analytics parameter for the UE in response to receiving the first request, the first request comprising a request to determine areas with an accuracy below a threshold, the threshold provided as part of at least one of the first request and the application requirement.

In one embodiment, the processor 505 exposes the determined second set of analytics to the external application. In one embodiment, the first request comprises at least one of a target area, an application identifier, a UE identifier, an identifier for a group of UEs, a service identifier, a time of validity, an accuracy threshold, accuracy requirements, a minimum confidence level threshold, and a UE route.

In one embodiment, the processor 505 compares the minimum confidence threshold of the first request with a confidence level of the first analytics parameter to derive the application layer analytics. In one embodiment, the first analytics parameter is received at the network node from a network data analytics function (“NWDAF”) of the mobile wireless communication network.

In one embodiment, the processor 505 discovers one or more NWDAFs to retrieve location analytics for accuracy for the UE within the target application. In one embodiment, the processor 505 at least one of retrieves location analytics for accuracy for one or more of the UE and a group of UEs from a network data analytics function (“NWDAF”) and retrieves location measurements for accuracy for one or more of the UE and a group of UEs from at least one location service producer.

In one embodiment, the transceiver 525 sends a second request to at least one network data analytics function (“NWDAF”) to receive location analytics for accuracy and receives the first analytics parameter for the accuracy of the measured location for the UE based on the second request. In one embodiment, the first and second analytics parameters are for a plurality of UEs within the target application. In one embodiment, the first analytics parameter comprises the location measurement accuracy parameter.

In one embodiment, the transceiver 525 transmits a request to an application data analytics enablement server (“ADAES”) for a location measurement accuracy parameter for a user equipment (“UE”) device, the location measurement accuracy parameter comprising at least one of a location accuracy prediction and a location accuracy sustainability for the UE. In one embodiment, the transceiver 525 receives, from the ADAES in response to the request, a location accuracy analytics report, the location accuracy analytics report comprising at least one of a prediction for the location accuracy of the UE and a sustainability of the location accuracy for the UE.

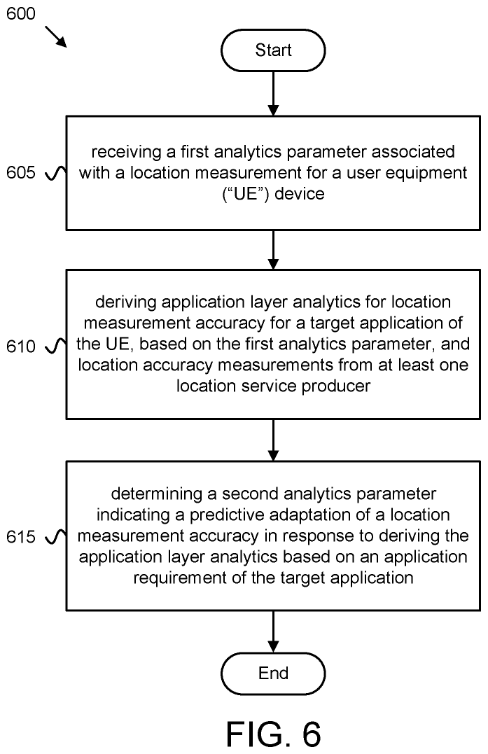

FIG. 6 is a flowchart diagram of a method 600 for location accuracy prediction at application data analytics enabler. The method 600 may be performed by a remote unit 105 such as a UE or a user equipment apparatus 400, or by a network entity such as a base node, a gNB, and/or the network equipment apparatus 500. In some embodiments, the method 600 may be performed by a processor executing program code, for example, a microcontroller, a microprocessor, a CPU, a GPU, an auxiliary processing unit, a FPGA, or the like.

In one embodiment, the method 600 begins and includes receiving 605 a first analytics parameter associated with a location measurement for a user equipment (“UE”) device. In one embodiment, the method 600 includes deriving 610 application layer analytics for location measurement accuracy for a target application of the UE, based on the first analytics parameter, and location accuracy measurements from at least one location service producer. In one embodiment, the method 600 includes determining 615 a second analytics parameter indicating a predictive adaptation of a location measurement accuracy in response to deriving the application layer analytics based on an application requirement of the target application. The method 600 ends.

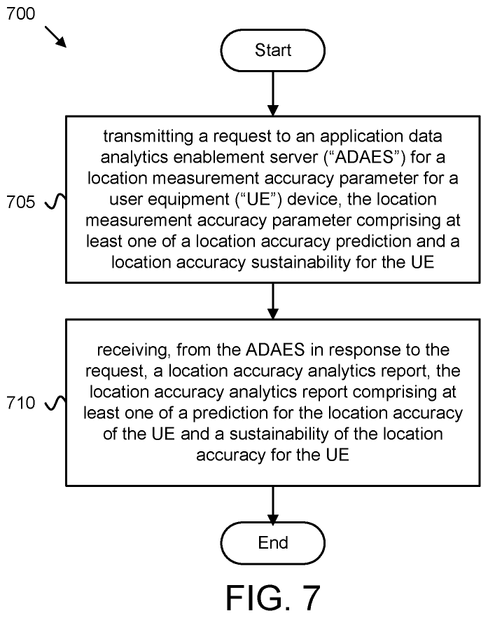

FIG. 7 is a flowchart diagram of a method 700 for location accuracy prediction at application data analytics enabler. The method 700 may be performed by a remote unit 105 such as a UE or a user equipment apparatus 400, or by a network entity such as a base node, a gNB, and/or the network equipment apparatus 500. In some embodiments, the method 700 may be performed by a processor executing program code, for example, a microcontroller, a microprocessor, a CPU, a GPU, an auxiliary processing unit, a FPGA, or the like.

In one embodiment, the method 700 begins and includes transmitting 705 a request to an application data analytics enablement server (“ADAES”) for a location measurement accuracy parameter for a user equipment (“UE”) device, the location measurement accuracy parameter comprising at least one of a location accuracy prediction and a location accuracy sustainability for the UE. In one embodiment, the method 700 includes receiving 710, from the ADAES in response to the request, a location accuracy analytics report, the location accuracy analytics report comprising at least one of a prediction for the location accuracy of the UE and a sustainability of the location accuracy for the UE, and the method 700 ends.

A first apparatus is disclosed for location accuracy prediction at application data analytics enabler. The first apparatus may include a remote unit 105 such as a UE or a user equipment apparatus 400, or by a network entity such as a base node, a gNB, and/or the network equipment apparatus 500. In some embodiments, the first apparatus includes a processor executing program code, for example, a microcontroller, a microprocessor, a CPU, a GPU, an auxiliary processing unit, a FPGA, or the like.

In one embodiment, the first apparatus includes a transceiver that receives a first analytics parameter associated with a location measurement for a user equipment (“UE”) device. In one embodiment, the first apparatus includes a processor that derives application layer analytics for location measurement accuracy for a target application of the UE, based on the first analytics parameter, and location accuracy measurements from at least one location service producer and determines a second analytics parameter indicating a predictive adaptation of a location measurement accuracy in response to deriving the application layer analytics based on an application requirement of the target application.

In one embodiment, the second analytics parameter comprises at least one of a predictive location accuracy sustainability indication, a predictive location accuracy change indication, a predictive location accuracy sustainability indication for a route of the UE with the application, and a predictive location accuracy change indication for a route of the UE with the application.

In one embodiment, the processor prescribes at least one of an application service operation and a behavior change based on the predictive location accuracy change. In one embodiment, the transceiver receives a first request comprising the application requirement of the target application from an external application for providing predictions for an accuracy of a location measurement for the target application of the UE.

In one embodiment, the processor identifies an area of interest with a predefined minimum location accuracy for a given time of day based on at least one of the first and the second analytics parameter for the UE in response to receiving the first request, the first request comprising a request to determine areas with an accuracy below a threshold, the threshold provided as part of at least one of the first request and the application requirement.

In one embodiment, the processor exposes the determined second set of analytics to the external application. In one embodiment, the first request comprises at least one of a target area, an application identifier, a UE identifier, an identifier for a group of UEs, a service identifier, a time of validity, an accuracy threshold, accuracy requirements, a minimum confidence level threshold, and a UE route.

In one embodiment, the processor compares the minimum confidence threshold of the first request with a confidence level of the first analytics parameter to derive the application layer analytics. In one embodiment, the first analytics parameter is received at the network node from a network data analytics function (“NWDAF”) of the mobile wireless communication network.

In one embodiment, the processor discovers one or more NWDAFs to retrieve location analytics for accuracy for the UE within the target application. In one embodiment, the processor at least one of retrieves location analytics for accuracy for one or more of the UE and a group of UEs from a network data analytics function (“NWDAF”) and retrieves location measurements for accuracy for one or more of the UE and a group of UEs from at least one location service producer.

In one embodiment, the transceiver sends a second request to at least one network data analytics function (“NWDAF”) to receive location analytics for accuracy and receives the first analytics parameter for the accuracy of the measured location for the UE based on the second request. In one embodiment, the first and second analytics parameters are for a plurality of UEs within the target application. In one embodiment, the first analytics parameter comprises the location measurement accuracy parameter.

A first method is disclosed for location accuracy prediction at application data analytics enabler. The first method may be performed by a remote unit 105 such as a UE or a user equipment apparatus 400, or by a network entity such as a base node, a gNB, and/or the network equipment apparatus 500. In some embodiments, the first apparatus includes a processor executing program code, for example, a microcontroller, a microprocessor, a CPU, a GPU, an auxiliary processing unit, a FPGA, or the like.

In one embodiment, the first method includes receiving a first analytics parameter associated with a location measurement for a user equipment (“UE”) device. In one embodiment, the first method includes deriving application layer analytics for location measurement accuracy for a target application of the UE, based on the first analytics parameter, and location accuracy measurements from at least one location service producer and determining a second analytics parameter indicating a predictive adaptation of a location measurement accuracy in response to deriving the application layer analytics based on an application requirement of the target application.

In one embodiment, the second analytics parameter comprises at least one of a predictive location accuracy sustainability indication, a predictive location accuracy change indication, a predictive location accuracy sustainability indication for a route of the UE with the application, and a predictive location accuracy change indication for a route of the UE with the application.

In one embodiment, the first method includes prescribing at least one of an application service operation and a behavior change based on the predictive location accuracy change. In one embodiment, the first method includes receiving a first request comprising the application requirement of the target application from an external application for providing predictions for an accuracy of a location measurement for the target application of the UE.

In one embodiment, the first method includes identifying an area of interest with a predefined minimum location accuracy for a given time of day based on at least one of the first and the second analytics parameter for the UE in response to receiving the first request, the first request comprising a request to determine areas with an accuracy below a threshold, the threshold provided as part of at least one of the first request and the application requirement.

In one embodiment, the first method includes exposing the determined second set of analytics to the external application. In one embodiment, the first request comprises at least one of a target area, an application identifier, a UE identifier, an identifier for a group of UEs, a service identifier, a time of validity, an accuracy threshold, accuracy requirements, a minimum confidence level threshold, and a UE route.

In one embodiment, the first method includes comparing the minimum confidence threshold of the first request with a confidence level of the first analytics parameter to derive the application layer analytics. In one embodiment, the first analytics parameter is received at the network node from a network data analytics function (“NWDAF”) of the mobile wireless communication network.

In one embodiment, the first method includes discovering one or more NWDAFs to retrieve location analytics for accuracy for the UE within the target application. In one embodiment, the first method includes at least one of retrieving location analytics for accuracy for one or more of the UE and a group of UEs from a network data analytics function (“NWDAF”) and retrieving location measurements for accuracy for one or more of the UE and a group of UEs from at least one location service producer.

In one embodiment, the first method includes sending a second request to at least one network data analytics function (“NWDAF”) to receive location analytics for accuracy and receives the first analytics parameter for the accuracy of the measured location for the UE based on the second request. In one embodiment, the first and second analytics parameters are for a plurality of UEs within the target application. In one embodiment, the first analytics parameter comprises the location measurement accuracy parameter.

A second apparatus is disclosed for location accuracy prediction at application data analytics enabler. The second apparatus may include a remote unit 105 such as a UE or a user equipment apparatus 400, or by a network entity such as a base node, a gNB, and/or the network equipment apparatus 500. In some embodiments, the first apparatus includes a processor executing program code, for example, a microcontroller, a microprocessor, a CPU, a GPU, an auxiliary processing unit, a FPGA, or the like.

In one embodiment, the second apparatus includes a transceiver that transmits a request to an application data analytics enablement server (“ADAES”) for a location measurement accuracy parameter for a user equipment (“UE”) device, the location measurement accuracy parameter comprising at least one of a location accuracy prediction and a location accuracy sustainability for the UE. In one embodiment, the transceiver receives, from the ADAES in response to the request, a location accuracy analytics report, the location accuracy analytics report comprising at least one of a prediction for the location accuracy of the UE and a sustainability of the location accuracy for the UE.

A second method is disclosed for location accuracy prediction at application data analytics enabler. The second method may be performed by a remote unit 105 such as a UE or a user equipment apparatus 400, or by a network entity such as a base node, a gNB, and/or the network equipment apparatus 500. In some embodiments, the first apparatus includes a processor executing program code, for example, a microcontroller, a microprocessor, a CPU, a GPU, an auxiliary processing unit, a FPGA, or the like.

In one embodiment, the second method includes transmitting a request to an application data analytics enablement server (“ADAES”) for a location measurement accuracy parameter for a user equipment (“UE”) device, the location measurement accuracy parameter comprising at least one of a location accuracy prediction and a location accuracy sustainability for the UE. In one embodiment, the second method includes receiving, from the ADAES in response to the request, a location accuracy analytics report, the location accuracy analytics report comprising at least one of a prediction for the location accuracy of the UE and a sustainability of the location accuracy for the UE.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A network device apparatus, the apparatus comprising:
a transceiver that receives a first analytics parameter associated with a location measurement for a user equipment (“UE”) device; and
a processor that:
derives application layer analytics for location measurement accuracy for a target application of the UE, based on the first analytics parameter, and location accuracy measurements from at least one location service producer; and
determines a second analytics parameter indicating a predictive adaptation of a location measurement accuracy in response to deriving the application layer analytics based on an application requirement of the target application.

2. The apparatus of claim 1, wherein the second analytics parameter comprises at least one of a predictive location accuracy sustainability indication, a predictive location accuracy change indication, a predictive location accuracy sustainability indication for a route of the UE with the application, and a predictive location accuracy change indication for a route of the UE with the application.

3. The apparatus of claim 2, wherein the processor prescribes at least one of an application service operation and a behavior change based on the predictive location accuracy change.

4. The apparatus of any preceding claim, wherein the transceiver receives a first request comprising the application requirement of the target application from an external application for providing predictions for an accuracy of a location measurement for the target application of the UE.

5. The apparatus of claim 4, wherein the processor identifies an area of interest with a predefined minimum location accuracy for a given time of day based on at least one of the first and the second analytics parameter for the UE in response to receiving the first request, the first request comprising a request to determine areas with an accuracy below a threshold, the threshold provided as part of at least one of the first request and the application requirement.

6. The apparatus of claim 4 or 5, wherein the processor exposes the determined second set of analytics to the external application.

7. The apparatus of claim 4, 5 or 6, wherein the first request comprises at least one of a target area, an application identifier, a UE identifier, an identifier for a group of UEs, a service identifier, a time of validity, an accuracy threshold, accuracy requirements, a minimum confidence level threshold, and a UE route.

8. The apparatus of claim 7, wherein the processor compares the minimum confidence threshold of the first request with a confidence level of the first analytics parameter to derive the application layer analytics.

9. The apparatus of any preceding claim, wherein the first analytics parameter is received at the network node from a network data analytics function (“NWDAF”) of the mobile wireless communication network.

10. The apparatus of claim 9, wherein the processor discovers one or more NWDAFs to retrieve location analytics for accuracy for the UE within the target application.

11. The apparatus of any preceding claim, wherein the transceiver:
sends a second request to at least one network data analytics function (“NWDAF”) to receive location analytics for accuracy; and
receives the first analytics parameter for the accuracy of the measured location for the UE based on the second request.

12. The apparatus of any preceding claim, wherein the first and second analytics parameters are for a plurality of UEs within the target application.

13. The apparatus of any preceding claim, wherein the first analytics parameter comprises the location measurement accuracy parameter.

14. A method of an application data analytics enablement server, the method comprising:
receiving a first analytics parameter associated with a location measurement for a user equipment (“UE”) device;
deriving application layer analytics for location measurement accuracy for a target application of the UE, based on the first analytics parameter, and location accuracy measurements from at least one location service producer; and
determining a second analytics parameter indicating a predictive adaptation of a location measurement accuracy in response to deriving the application layer analytics based on an application requirement of the target application.

15. A network device apparatus, the apparatus comprising:
a transceiver that:
transmits a request to an application data analytics enablement server (“ADAES”) for a location measurement accuracy parameter for a user equipment (“UE”) device, the location measurement accuracy parameter comprising at least one of a location accuracy prediction and a location accuracy sustainability for the UE; and
receives, from the ADAES in response to the request, a location accuracy analytics report, the location accuracy analytics report comprising at least one of a prediction for the location accuracy of the UE and a sustainability of the location accuracy for the UE.
